(19) United States
(12) Patent Application Publication
(10) Pub. No.: US 2010/0002555 A1
(43) Pub. Date: Jan. 7, 2010

(54) CONTROL SIGNAL FOR THREE DIMENSIONAL OPTICAL DATA STORAGE

(75) Inventor: Yair Salomon, Jerusalem (IL)

Correspondence Address: OLIFF & BERRIDGE, PLC, P.O. BOX 320850, ALEXANDRIA, VA, 22320-4850, US

(73) Assignee: MEMPILE INC., Wilmington, DE (US)

(21) Appl. No.: 12/521,232

(22) PCT Filed: Dec. 31, 2007
(86) PCT No.: PCT/IB07/04143

§ 371 Date: Jun. 25, 2009

Related U.S. Application Data
(60) Provisional application No. 60/882,630, filed on Dec. 29, 2006.

(51) Int. Cl. G11B 7/0037; G11B 7/085

(52) U.S. Cl. 369/53.2; G9B/7.042; G9B/7.005

(57) ABSTRACT

A method is presented for use in determining a degree of quality of a multi-layer optical data carrier in its at least partially recorded state. Predetermined first data is provided being indicative of a qualified, at least partially recorded multi-layer optical data carrier. This data corresponds to an optical response obtainable from a specific data carrier under predetermined conditions of an optical scan of the rotating data carrier. A data carrier being qualified is scanned by at least one optical beam under said predetermined conditions of the scan, and a first control signal from the data carrier is detected and data indicative of the detected control signal is generated. The so generated data is processed to determine a relation with said predetermined data. The determined relation is used for determining a degree of quality of said scanned data carrier.

### FIELD OF THE INVENTION

The present invention is generally in the field of optical data storage, and relates to a method of deriving a control signal from the data storage indicative of the data storage quality, particularly useful for three-dimensional data storage.

### BACKGROUND OF THE INVENTION

The existing approach for optical storage media is based on the use of reflective media. Accordingly, commercially available optical data carriers (disks) have one-layer or dual-layer geometry.

In a three-dimensional data storage, data is recordable in the form of three-dimensional pattern of spaced-apart recorded regions arranged in multiple (more than two) layers (virtual layers or planes). The layers are located at different depths in the volume of a 3D data storage media and have different numbers of recorded regions (marks). The layer may be either pre-formatted or unformatted. The formatted layers may be partially recorded with data marks being interleaved with formatting marks. Each formatted or recorded layer may contain a different amount of marks and different mark patterns. The formatted layers may be interspaced by data layers. The volume of the medium above or below a formatted layer may allow recording a number of data layers therein. The determined location of the interrogating/recording beam(s) focus, relative to the location of the recorded layers within a three-dimensional optical storage media is used for the recording and reading processes in said media and for the post-manufacturing/recording quality control.

Examples of such a three-dimensional data carrier, and those of methods of formatting and data recording/reading in the three-dimensional data carriers, are disclosed for example in WO 2006/0117791, WO 2006/075326, WO 2001/073779, WO 2006/075328, WO 2003/070689, WO 2005/015552, WO 2006/111972, WO 2006/111973, WO 2006/075327, WO 2006/075329, all assigned to the assignee of the present application. In such three-dimensional data carrier, information is stored in a volume comprising an active medium. The active medium is capable of changing from a first state to a second state in response to multi-photon interaction (e.g. two-photon interaction), where the first and second states of the medium have different optically detectable (non-linear) properties such as fluorescence response.

### GENERAL DESCRIPTION

There is a need in the art for easy and reliable monitoring/controlling of the quality of a three-dimensional data storage by enabling use of a control signal structure that would provide layer/track relative location, determination and assessment of parameters of at least partially recorded data carrier. Additionally, multi-layered data carriers are designed to contain significant amount of information. Therefore, it is required to be able to skip from a first data stream (first layer) retrieval to a second data stream (second distant layer) quickly and efficiently.

The expressions “three-dimensional data carrier” and “three-dimensional recordable media” used herein refer to a carrier/media for recording/reading data comprising a three-dimensional information pattern (including a format pattern and/or data pattern) in the form of spaced-apart recorded region (marks) arranged in multiple layers. More specifically, the present invention is useful for non-linear carrier/media, in which recording and/or reading process(es) is/are based on multi-photon interaction.

The expression “at least partially recorded data carrier” signifies a data carrier having format pattern and/or data pattern, which may include recorded or embossed patterns on layers defined by surfaces within the three-dimensional recording media volume or surfaces of surrounding substrate(s) or recorded patterns in a formatted base layer. The data carrier in its at least partially recorded state includes a plurality of layers including multiple data layers, or multiple formatting layers, or at least one data layer and at least one formatting layer.

Among the formatted carrier parameters that require control may be an axial distance between the layers and number of layers (virtual layers or planes). This includes control of the distance between the first outer surface (e.g. top surface) of the data carrier (e.g. disc-like body) and a first close to that surface formatted/recorded layer, and the distance between the opposite outer surface (bottom surface) of the disc and the last recorded/formatted layer. Some data carriers may be produced with one or more embossed layers that may serve as reference for the optically recorded layers. Such three-dimensional data storage having one or more reference layers are disclosed for example in WO07069243 and WO07083308, both assigned to the assignee of the present application. The accumulated axial and/or radial position deviation of the layers may be another parameter to be controlled.

One of the problems associated with controlling the quality of a three dimensional data carrier is that the distance between the layers may be non-homogeneous (non-uniform). This may be due to recording of groups of layers in different recording sessions which may be performed in different drive setting (e.g. after removal and insertion of the disk into the drive) or in different drives, wherein for different parameters such carrier assembly parameters or drive calibration parameters may be different.

In addition, each of the tracks associated with such layer may contain a different number of formatting marks. Further, the marks may be not homogeneously distributed along the track and may be uncorrelated in position. Thus, direct measurement of location of such layers and tracks is a long and tedious task and is practically impossible.

Additionally, radial cross track signals serve various purposes such as for verification of data integrity and quick scan between different sectors in a data layer. It is required to get a signal characteristic of the recorded tracks in a layer by open scan in the radial direction.

In a data carrier having reference layer(s), a recorded layer is related (e.g. correlated) to the reference layer during the recording session. However, this correlation has drive dependent properties such as potential offset between recording and servo foci and drive dependent dynamic response and carrier assembly dependency. In addition, during the life time of the data carrier, deformations might occur and the correlation might change. Furthermore, one has to take into account possibly different partition of the recorded layer into zones in different recording sessions (as compared to the reference layer). Therefore, there is a need to extract track and layer information, e.g., radial cross track signal, directly from recorded data in the data layer.

In conventional reflective media, radial cross track control signal is derived by having the optical stylus scan in open loop in the radial direction while the disk is rotating and having the axial (focus) control locked on the reflective surface of the data layer. Direct adaptation of this approach, i.e. directly locking read beam in the focus direction and performing open loop scan of the read beam focus in the radial direction may be unachievable for derivation of the cross track signal from a data layer of a three-dimensional carrier (non-linear media). This is because the tracking of the data layer in both focal direction and radial direction in such media is responsive in low frequencies and typically supports derivation of tracking signal only during scanning along the track. This is especially true for tracking methods that do not rely on the use of position sensitive detectors (such as sectioned detectors), while tracking methods that utilize non position sensitive detectors are an important set of the methods for tracking in the three-dimensional data carrier.

The present invention solves the above problem by providing an indirect method to control the focal position of a reading light spot in the radial direction, by using a reference layer (reflection of a reference beam from the reference layer) for controlling the focal (axial) position of both reference beam and reading beam. The control is performed in a “slave-master” mode: In the axial direction the determined relation between the reading beam focus and the reference beam focus is controlled to be kept at a fixed relation, and at the same time in radial direction the position of the reading beam spot (focused) is being controlled in a scan mode either in open loop or by different feedback, e.g. by feedback of the cross track signal (e.g. by count of the number of crossed tracks).

In comparison to the axial control signal extraction, movement of focused reading beam spot can be relatively quicker as data density and contrast along the track direction (radial direction) is higher as compared to the data density and contrast across the layers (focal or axial direction). The cross track signal derived in this mode is periodic, similar to a sine function for dense tracks; the difference of the signal from perfect periodicity may be used as one of the recording quality measures and the signal is indicative, inter alia, of the distance between tracks spaces between separate annular zones and the number of scanned tracks.

It should also be noted that during the cross track scan, an objective lens unit of the optical system may be practically in its rest point. As a result, potential dynamic radial offsets between the focal positions of the reading and reference beams are minimized. Additionally, receiving two cross-track signals (from the reference layer and the data layer) enables to better analyze the position of each beam focus and identify more reliably and accurately the tracking position.

Thus, the present invention provides a novel technique for determining a degree of quality of a multi-layered optical data carrier, and provides a control signal structure which is unique for a specific data carrier or the data carrier type. Such control signal is obtainable from a data carrier and has a structure enabling characterization of a degree of quality of said data carrier. To this end, predetermined data is provided being indicative of at least a first desired control signal for at least partially recorded multi-layer optical data carrier, where this desired control signal corresponds to an optical signal obtainable from a qualified multi-layered optical data carrier in its at least partially recorded state, under predetermined conditions of an optical scan of the rotating data carrier.

The expression “qualified data carrier” signifies a data carrier having an acceptable degree of quality. The expression “specific data carrier” is used herein as referring to a data carrier or a data carrier type.

It should be understood that data indicative of a desired control signal is formatted as a machine readable code, and can be storable in any suitable machine readable media in the form of software and/or hardware setup.

In the description below, the term “control signal” is at times referred to a result of an optical response profile from a data carrier detected during an optical scan of the rotating data carrier. The control signal is a feedback signal from the data carrier to the associated data carrier drive system (including recording/reading optical unit, disc rotating mechanism, and a controller), and is informative about a relation between the drive system and the data carrier and/or about the data carrier arrangement. The information about relation between the drive system and the data carrier may include a position of the focal plane of the scanning beam relative to a certain location in the data carrier (e.g. outer surface of the data carrier, reference layer plane in the data carrier, etc.). The information about the data carrier arrangement may include information about the arrangement of layers, distances between the layers (including a distance between reference layers, between a data layer and a reference layer, etc.).

It should also be understood that the control signal is not a signal indicative of user recorded data (to be retrieved in a data reading procedure). Accordingly, an optical scan of the data carrier aimed at deriving a control signal is different from the scanning procedure needed for reading the user recorded data.

The term “scanning” or “scan” used herein generally refers to providing a relative displacement between the data carrier and the focused optical beam(s). Such scanning is implemented by the data carrier rotation and movement of the focal spot (e.g. by the beam deflection).

The optical scan for deriving the control signal includes a scan through the carrier (along an optical axis of the drive system which is parallel to the axis of rotation of the data carrier), and/or along a radial axis (substantially orthogonal to a principle data reading direction in the data carrier). The optical scan aimed at deriving the control signal is performed under the predetermined conditions under which the actual reading of the user recorded data cannot practically be obtained because it does not involve the entire scanning of the layer's tracks. In other words, scanning of a multi-layered data carrier to derive a control signal (feedback signal) in the context of this invention refers to motion (relative displacement between the data carrier and the focal spot) providing information about the data carrier structure independent of tracking the user recorded data. As will be described below, such scanning provides coarse level information about the data carrier and/or its relative position to the drive system, rapidly and efficiently without having to detect and process enormous amounts of data.

It should also be noted that predetermined data corresponding to a desired control signal from the data carrier is typically defined during the development of the data carrier, the data carrier drive system and their standards. Fine details such as specific scanning speed ratios and optimal filtering parameters are refined at this stage, however, as the data carrier generations evolve, the drive system has to accommodate for several sub-types of the data carriers within a growing compatibility requirement range. In such scenario, it may be valuable to have the fine details of data corresponding to the control signal extracted directly by the drive system. For example, the drive system that is designed to read a data carrier at higher speeds compared to a first generation data carrier that is compatible to a first reading-standard may be required to use this data carrier using the second reading standard, e.g. a rotation speed higher than the rotation speed defined in the standard for that first data carrier generation. Fixed predetermined relations for such data carrier may not be applicable as the data carrier is not required to provide support for the new operating regime, however the drive system may use given basic conditions for operating regimes to find how to adapt them to the data carrier working in the unspecified for regime. For that purpose, the drive system may for example operate in the so-called “learning mode” using test regions provided in the data carrier or studying at least a part of the actually recorded user data.

It should also be understood that the expression “at least one optical beam” used herein signifies a beam capable of causing required interaction with a data carrier to generate an optical response therefrom.

Typically, the control signal includes multiple spaced-apart amplitude peaks corresponding to an arrangement of the multiple layers in the data carrier detectable under the predetermined conditions of the optical scan of the rotating data carrier. It should be understood that the term “peak” used herein signifies a change from one range of values to a second range of values in the detected and processed signal, i.e. either one of the local maximal and local minimal values of the optical response. The data carrier being qualified is scanned by an optical beam under these predetermined conditions of the scan, a control signal (an optical response profile) from the data carrier is detected during the scan, and data indicative thereof is generated. The so generated data indicative of the control signal (optical response profile) is processed and a relation with the corresponding predetermined data is determined and used for estimating a degree of quality of said scanned data carrier.

Thus, according to one broad aspect of the invention, there is provided a method for use in determining a degree of quality of a multi-layer optical data carrier in its at least partially recorded state, the method comprising:
providing predetermined first data indicative of a qualified, at least partially recorded multi-layer optical data carrier, said data corresponding to an optical response obtainable from a specific data carrier under predetermined conditions of an optical scan of the rotating data carrier;
scanning a data carrier being qualified by at least one optical beam under said predetermined conditions of the scan, detecting a first control signal from the data carrier and generating data indicative of the detected control signal;
processing said generated data and determining a relation with said predetermined data, and using the determined relation for determining a degree of quality of said scanned data carrier.

In some embodiments of the invention, the predetermined conditions of the scan comprise a predetermined relation between a speed of rotation of the data carrier during the scan and a speed of moving a focal plane of the scanning beam along an axis through the data carrier (e.g. an axis parallel to an axis of rotation of the data carrier), and preferably also a scan at a predetermined speed along the radial direction.

Preferably, the relation to be determined between the data indicative of the detected control signal and the predetermined data indicative of a desire control signal is selected to enable detection of each of the scanned layers in the data carrier by optical response from a predetermined number of recorded regions in said data layer, for example the optical response from the single recorded region in each data layer.

The control signal from the data carrier may be indicative of distances between adjacent layers from the multiple layers in the data carrier; and/or indicative of a location of an endmost layer (upper most or lowermost) of the multiple layers with respect to a close thereto outer surface of the data carrier.

In some embodiments of the invention, data indicative of at least one second desired control signal is predefined for at least partially recorded multi-layer (non-linear) optical data carrier. This at least one second desired control signal has a second spatial profile comprising multiple spaced-apart amplitude peaks corresponding to an arrangement of tracks (circular or spiral) in at least one of the multiple layers in the data carrier detectable under second predetermined conditions of an optical scan of the layer in a rotating data carrier. This second scan is a scan in a direction across the tracks in the layer, i.e. along an axis substantially orthogonal to a principle data reading direction in the data carrier.

By scanning at least one layer in the data carrier being qualified by an optical beam under the second predetermined conditions of the scan and detecting a control signal (an optical response profile) from said at least one layer in the data carrier, a relation (correlation) can be determined between data indicative of the detected control signal and said predetermined data indicative of the desired control signal. This relation is then used for determining a degree of quality of the scanned data carrier.

In case the data carrier being qualified has one or more reference layers in association with at least one of said multiple layers, the radial and/or axial (open loop) scanning of the at least one layer in the data carrier comprises focusing a reference beam onto the reference layer and detecting response (e.g. reflection) of this reference beam. By this, the radial scanning of the layer by the focused optical beam can be controlled in the vertical (focus) direction, and the control signal from the data layer can be determined. As will be described further below, the detection of the control signal assisted by the reference layer eliminates a need for using a position sensitive detector.

In case the data carrier is being configured with more than one reference layers responsive to reference beam and to recording/reading beam (as disclosed in WO 2007/069243 to the same assignee, which publication is incorporated herein by reference), the scanning comprises focusing a reference beam onto the first reference layer and detecting reflection of the reference beam from the first reference layer, and focusing a reading optical beam onto the second reference layer and detecting reflection of the reading beam from the second reference layer. This provides detection of control signals that enables determination of a degree of quality of each of the reference layers, as well as a relation (e.g. correlation) between the layers, and provides for performing a long range radial scan along the radial direction. Locking the optical system (the focal positions of the optical beams) in a master-slave mode, wherein only one (first) of the focus positions (“master”) is locked onto the respective layer and the other (“slave”) is kept at a predetermined relation to the “master”, enables derivation of a focus error signal indicative of the degree of focus onto the second layer and determination of a degree of quality correlation between the respective layers in the focus axis direction.

According to another aspect of the invention, there is provided a method for use in determining a degree of quality of a non-linear optical data carrier in its at least partially recorded state, the method comprising:
providing predetermined second data indicative of a qualified at least partially recorded non-linear optical data carrier, said predetermined second data corresponding to an optical response obtainable from at least one layer, respectively, in a specific optical data carrier under second predetermined conditions of an optical scan of the rotating data carrier;
scanning at least one layer in the data carrier being qualified by an optical beam under said second predetermined conditions of the scan, and detecting at least one second control signal from said at least one layer in the data carrier;
processing data indicative of said at least one second detected control signal and determining a relation with said predetermined second data, and using the determined relation for determining a degree of quality of said scanned data carrier.
According to some embodiments of the invention, the second control signal has a spatial profile comprising multiple spaced-apart amplitude peaks corresponding to an arrangement of tracks in the layer detectable under second predetermined conditions of an optical scan of the layer in the rotating data carrier.

According to yet another aspect of the invention, there is provided data storable in machine readable media and retrievable as a machine readable code, said data being indicative of a qualified at least partially recorded multi-layer optical data carrier and corresponding to a result of an optical response profile obtainable from a specific data carrier under predetermined conditions of an optical scan of the rotating data carrier along axial and radial directions of the scan.

Such data is accessible by or inherently programmed in (being readable as software and/or hardware media) the data carrier drive system. Preferably, for more flexibility, some relevant data is recorded in the data carrier itself to be able to adapt the drive behavior to evolving the data carrier standards.

It should be understood that such predetermined data indicative of a desired optical response profile may define relations between various control signals and a desired optical response profile defining various degrees of quality for the data carrier.

According to yet another aspect of the invention, there is provided a control signal structure characterizing at least partially recorded multi-layer optical data carrier, said control signal comprising multiple spaced-apart peaks corresponding to an arrangement of the multiple recorded layers in the carrier.

In some embodiments of the invention, a number of the multiple spaced-apart peaks corresponds to a number of the layers in the data carrier.

In some embodiments of the invention, each of the multiple peaks corresponds to an optical response from a recorded region in the respective layer to an interacting focused optical beam during the data carrier rotation with a predetermined rotational speed and a focused optical beam scan along an axis parallel to the axis of rotation.

According to yet further aspect of the invention, there is provided a drive system for recording/reading data in an optical multi-layer data carrier, the drive system being configured and operable for irradiating the data carrier with at least one focused optical beam to cause an optical response from the data carrier, and detecting and analyzing said optical response to determine data indicative of at least one of the following: a relation between the drive system and the data carrier; and the data carrier arrangement.

According to yet another aspect of the invention, there is provided a drive system for recording/reading data in an optical multi-layer data carrier, the drive system being configured and operable for scanning a data carrier by at least one focused optical beam under predetermined condition of the scanning, detecting an optical response of the data carrier to said at least one focused optical beam, and generating a control signal indicative thereof said control signal being indicative of a degree of quality of the data carrier.

As indicated above, the present invention is more specifically useful with a non-linear optical media and is therefore described below with respect to this specific application.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is schematic illustration of a cross section of a formatted three dimensional non-linear optical data storage carrier.

FIG. 2 is schematic illustration of a top view of a formatted three dimensional non-linear optical data storage carrier.

FIG. 3 is a schematic illustration of some of the details of a recorded mark reading process.

FIG. 4 is a schematic illustration of the derived control signal in the case where the axial speed of the focused spot is substantially larger than the medium speed.

FIG. 5 is a schematic illustration of the control signal derived in the case where the axial speed of the focused spot relative to the medium speed is substantially slower.

FIG. 6 is a schematic illustration of control signal derived at proper settings and relations of the rotational, axial and radial speeds.

FIG. 7 is a schematic illustration of some of the elements of determining location of tracks residing in the same virtual layer.

FIG. 8 exemplifies an optical system capable of refocusing the reading beam, suitable to be used in the invention.

### DETAILED DESCRIPTION OF EMBODIMENTS

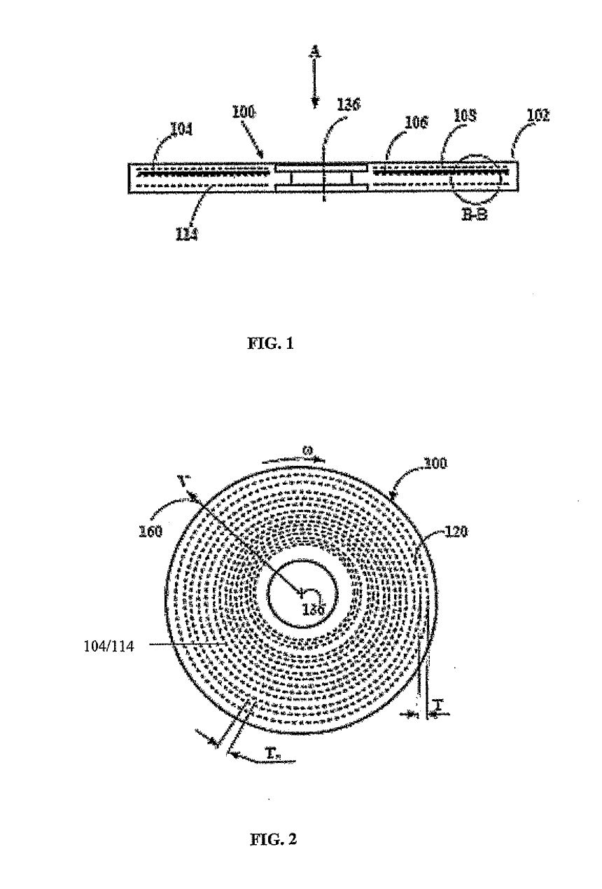

Reference is made to FIG. 1, which is a schematic illustration of a cross section of a three dimensional non-linear optical storage (data carrier) 100 according to an example of the invention. Generally, the data carrier of the present invention is a single- or multi-plate assembly, where each such plate is a monolithic body of a non-linear recordable media configured for recording/reading information in/from multiple layers. In the present example of FIG. 1, the data carrier having a single-plate recordable medium is shown. The recordable medium is made of a transparent or translucent material 102, for example a polymer material, such as a copolymer with methylmethacrylate and compositions including acrylate and methacrylate monomers. The above indicated publications WO2006/111972 and WO2006/111973 disclose various examples of the carrier architecture. An active moiety, capable of changing its state from one isomeric form to another upon interaction with electromagnetic energy, such as laser radiation, is bound to polymer 102 (embedded in the polymer matrix).

For the purposes of the present invention, the data carrier is in its at least partially recorded state, namely including a recorded or embossed format pattern and/or data pattern. In the present non-limiting example of FIG. 1, the data carrier 100 includes both the format pattern and the data pattern. Data is recorded in the data carrier medium 100 as a pattern of spaced-apart recorded regions (marks) 104 located on virtual layers 106. Each record of the mark 104 may represent a channel signal and the marks' arrangement in tracks may be used for tracking purposes (e.g. WO 03/077240 and 2007/069243 both assigned to the assignee of the present application and being incorporated herein by reference). Alternatively, a pattern of servo or formatting marks 114, that serves to indicate coordinates of a reading spot (reading beam) relative to a nominal, is optically recorded in the carrier 100 on a plurality of layers 108. Formatting marks 114 may be located at different depths in the carrier 100 and may be similar or sometimes identical to data marks 104, although the structure of layers 108 may be different from the structure of layers 106. One or more formatting or servo layers 108 may be associated with one or more data containing layers 106. Accordingly, each formatting or servo layer 108 is interspaced or interleaved by one or more data-containing layers 106. The layers are shown in the figure schematically, for explanation purposes only. As indicated above, the data carrier in its at least partially recorded state may include a plurality of layers including multiple data layers, or multiple formatting layers, or at least one data layer and at least one formatting layer.

As shown in FIGS. 4-6 and will be described more specifically further below, a distance between the layers (formatted and/or data layers) might not be homogeneous or uniform, e.g. because of systematic choice to keep at a certain distance layers recorded at different sessions.

Reference is now made to FIG. 2 illustrating the recorded marks' arrangement within a layer. This may be formatting marks 114 or data marks 104. The marks (recorded regions) are located on circular or spiral tracks, circular tracks 120 being shown in the present example. The track pitch T, which is the distance between the centerlines (nominal track centers) of a pair of adjacent tracks measured in a radial direction, may be about 800 nanometers. The typical distance T₁ between two successive formatting marks 114/104 may be about 600 microns on the outer tracks and smaller on the inner tracks. Spiral or circular tracks 120 have an essentially common rotation axis 136, which is the geometrical center of the disc-like information carrier body 100.

In a three-dimensional data carrier, i.e. multi-layer data carrier, each layer has the above-exemplified configuration, where as indicated above, the distance between two adjacent layers or between adjacent groups of layers may vary across the disk.

It should be noted that in some formatted partially recorded data carriers, tracks are defined by servo marks arranged at offset from a nominal track. In some data carriers, data is arranged in layers in which each track comprises sub-tracks, above, below and to the sides of the nominal track. For some purposes, such as layer identification while scanning across the layer or the track detection during scanning across the track, determination of the fine track structure is not required and only the coarse details such as track or layer nominal position are relevant. Thus, such complex tracks may be treated as simple nominally linear track, whereas the fine details of the track may be averaged out during the processing of the detected signal and the resulting control signal.

According to the invention, the data carrier quality (a degree of quality) can be monitored and used by defining certain data selected to correspond to a desired optical signal or control signal obtainable from a qualified, at least partially recorded data carrier under predetermined conditions of an optical scan of the data carrier, where this optical signal is unique for the data carrier or the data carrier type. In some embodiments of the invention, the control signal has a spatial profile comprising multiple spaced-apart peaks corresponding to an arrangement of layers in the carrier.

Generally, the control signal from a data carrier may be indicative of the location of a focal position of an optical beam (scanning beam) relative to the data carrier, e.g. indicative of the read focus position relative to the actual layer location; and/or indicative of the arrangement of at least some layers in the data carrier; such information describing a degree of the formatting/recording quality of the data carrier.

Thus, according to some embodiments of the invention, the control signal is indicative of interaction of the focused reading beam (spot) with the recorded pattern and the vertical scan of the focused reading beam (scan along an axis parallel to the axis of rotation of the data carrier). Discs typically have substantial axial and radial run outs, typically most prominently at the frequency of the disc rotation. The present invention provides also for deriving required control signal in presence of substantial run-outs. Alternatively or additionally, the invention provides for identifying the data storage quality by providing a method for deriving and defining a second control signal indicative of the relative position of a scanning spot in a specific layer. This second control signal is obtained while scanning the data carrier in the radial direction.

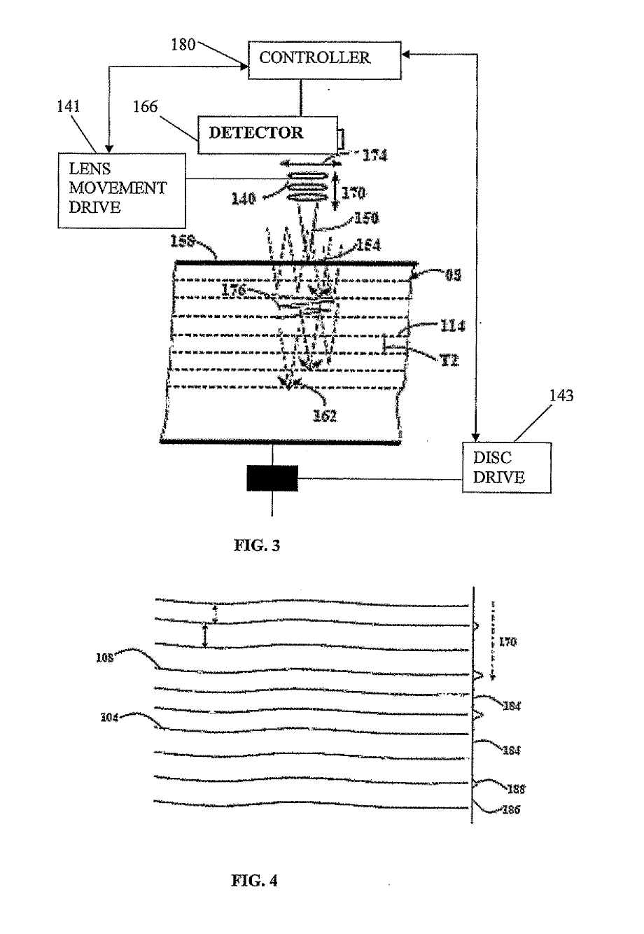

Reference is made to FIG. 3 exemplifying how the first control signal (axial or focal direction) can be used for determining a degree of quality of an optical non-linear data carrier. Predetermined data indicative of a desired optical response for the specific data carrier or data carrier type is first provided. Such optical response has a spatial profile formed by multiple spaced-apart amplitude peaks corresponding to an arrangement of multiple layers in a qualified at least partially recorded data carrier detectable under predetermined conditions of an optical scan of the rotating data carrier. As shown in the figure, a recording/reading system or disc drive system is provided, including an optical system 140 including a light source unit (not shown) producing at least one optical beam 150; light directing unit including inter alia a lens unit associated with a lens movement mechanism 141, a light detector unit 166, a disc drive mechanism 141, and a control unit 180. Such disc drive system is used for deriving a profile of an optical response from the data carrier being qualified. The drive system may initially operate to focus the reading laser beam 150 onto a reading spot 154 located on a predetermined surface or layer, which may be an outer surface 158 of the data carrier 100 or an arbitrary data layer, or reference layer (not shown here), or a partially recorded base layer or reference layer (used for formatting and tracking purposes—see for example WO 2005/015552 or WO 2007/069243 both assigned to the assignee of the present application and being incorporated herein by reference. The focusing of the reading beam onto a certain determined depth in the data carrier may be achieved by tracking a layer at said predetermined depth in the data carrier. In case the data carrier is of a type having one or more reference layers, the drive system is configured for generating a reference beam of a wavelength different from that of the reading beam and directing the reference beam onto the data carrier in a certain determined relation with the reading beam propagation and for detecting reflection of the reference beam from the data carrier. In this case, focusing of the reading beam onto a certain determined depth in the data carrier may be achieved by setting the optical system at certain offset between the reading and reference beams and tracking a reference beam.

There are several options for determining the focal spot location with respect to the data carrier. According to one possible option, the spot 154 location may be derived from the optical beam interaction with surfaces of the data carrier, such as the outer surface of the carrier or the reference layer. The latter presents a reflective interface between two recording layers or between recording and non-recording layer, and has a certain pattern (grooves and/or pits) enabling use of a reference beam reflection from the reference layer to control the recording/reading beam scan. This is described in the above-indicated publications WO07069243 and WO07083308, both assigned to the assignee of the present application, incorporated herein by reference.

According to another option, the focusing of the reading beam onto the outer surface of the data carrier may serve as a reference point to start a scan to derive the optical response profile. In this case, the distance from the optical system 140 (from the focusing lens) to the outer surface 158 of the carrier 100 may be predefined/calibrated or measured using laser beam reflections, optical or capacitive sensing methods or any other known technique.

In some cases, the spot location might not be predetermined and the optical response profile is derived without any starting reference point.

The relative depths of the recorded data and/or formatting layers are derived from the temporal profile of the optical response. The optical response profile results from the interaction of the focused reading beam and a pattern of marks recorded in the layers/tracks in the axial direction. In order to create the temporal profile, the focal position of the reading beam 154 is moved along the optical axis of the optical system 140 in a direction indicated by arrow 170 while the carrier 100 is rotated around axis proximal to its axis of symmetry 136 with a rotational or first speed c controlled by the to disc drive 143. The lens movement mechanism 141 operates to move the focal position of the spot 154 continuously so as to refocus the beam continuously on different recorded and or formatted layers 106 and 108. Generally, any known suitable technique can be used for such spot movement, for example that disclosed in WO 2004/032134, WO 2007/069243, both to the same assignee, or in U.S. Pat. No. 5,677,903, all these which publications being incorporated herein by reference. As disclosed in some of the above references, the axial movement and spherical aberration compensation may be achieved by using a set of variable thickness plates. In such case, the focusing system is configured for performing a stepwise focusing (e.g., WO 2007/069243) and the process may be broken into steps where during each step the beam is continuously focused. Yet another possible technique for continuous refocusing of the scanning beam on different recorded layers in the data carrier will be described below with reference to FIG. 8.

Combination of the axial spot movement (displacement of the focal position of the reading beam along the optical axis) and the carrier rotation allows the focal beam spot 154 to access mark 114 (or 104) recorded in any location on track 120 and in any layer 106 (or 108) and to generate the continuous optical response profile from the data carrier's layers by interaction of the spot with at least one recorded region and its surrounding space associated with each recorded layer. The axial profile of the optical response determines the relative position of the focused spot within the depth of the multi-layer optical data storage (disc).

Thus, the focused spot 154 interaction with the recordable media, particularly with marks 114 (or 104) and spaces between them (generally with the marks pattern) generates the optical response profile constituting a control signal of the data carrier being monitored/qualified. The signal is continuous one in a monolithic medium with different values for space and mark positions. Read-out signal or optical response signal 162 is typically luminescent radiation detected by the detector unit 166. It should be understood that the technique of the present invention for detection of a control signal eliminates a requirement for a position sensitive detector as it relies on the amplitude of the read-out signal for the derivation of the relative focal point position and for the determination of the degree of quality of the control signals. The output of the detector is connectable (via wires or wireless signal transmission) to the controller 180. The latter is configured for using the predefined data indicative of the desired optical response profile (at least first data corresponding to the optical response obtainable by generally vertical scan) and processing the detected control signal from the data carrier being qualified. A relation between the detected control signal and the predetermined data is indicative of a degree of quality of the data carrier.

Spot 154 might occasionally be located outside a recorded track, and might in such case scan a significant depth of the recordable media in the carrier 100 without interacting with a recorded marks pattern. Marks may be relatively sparsely located in the monolithic medium. Marks typically occupy about 20%-50% of the cross sectional area of a completely recorded virtual layer and typically less than 1% (one percent) of the cross section of a partially recorded/formatted layer or plane in the disk. Thus, when the focused spot rapidly moves in a medium/carrier with only partially recorded layers, a chance of passing through a layer without interacting with a mark and generating a signal (i.e. without having the focus location overlapping with a mark position) is higher than 50%. (Here, the term “rapid” signifies that the disc might be considered stationary, as compared to the axial movement speed.) To avoid such cases (i.e. no interaction between beam focus and marks in a certain layer), the axial movement of the focal reading spot 154 in the direction of arrow 170 (axial direction) may be augmented by simultaneous complementing (orthogonal to the optical axis) movement, or scanning movement, of the reading spot 154 in a radial direction 160 as shown by a curve 176. This radial scan is achieved by a relative displacement between the optical beam and the data carrier, e.g. by appropriate operation of the lens drive mechanism 141 to move the lens. The speed of the radial movement of spot 154 should preferably be such as to ensure the spot interaction with at least one recorded on track 120 mark 114. This may be achieved by controlling the ‘miss’ probability, i.e. the probability of passing through a layer without detecting signal indicative of the layer. The speed of movement in the radial direction is set to a value that allows reading of a number of track spirals during the time interval in which reading spot 154 is located within the effective depth of the layer. For example, if the effective depth of focus of the beam is about 2 microns and it is determined that for sufficient signal averaging the beam should detect signal of 20 tracks (track pitch being 0.8 micron, then at the time it takes the beam focus to pass 2 microns in the vertical direction (axial scan) the radial movement should be 16 microns. The focal beam width and the track pitch parameters should preferably also be taken into account to ensure that tracks are at least partially detected by the scanning beam.

In order to avoid erroneous reading, the speeds values and a relation between the axial and radial speeds of the spot 154 movement should preferably be carefully controlled, for a given rotational speed. In this connection, reference is made to FIGS. 4-6 exemplifying different control signals obtainable at different scan conditions.

FIG. 4 illustrates the principles of the control signal 162 detection in the case when the speed of the axial motion of the focused spot 154 is substantially larger than the rotational speed of the data carrier 100 and the speed of the movement of the spot in the radial direction. Peaks 186 in the detected signal 162 correspond to the focused spot 154 location between the recorded layers 108 or 104 during the axial movement (scanning) of the focused spot 154, and valleys 188 in the signal 162 correspond to the focused spot location in the at least partially recorded virtual layer 104 or 108. Layers 108 and 104 may be spaced on different distances from each other. Since the axial speed is too fast, some of the layers 108 or tracks 120 (FIG. 2) may be missed, i.e. the beam may pass in spaces between tracks or in locations unrecorded in the partially recorded layers, and the signal will not indicate detection of recorded marks, as shown by gap 184. Thus, a higher than necessary axial speed will lead to missing of signal parts (some not detected layers), and result in the non-uniform control signal, resulting in some not detected layers and consequently wrong assessment of the relative location of other layers.

FIG. 5 illustrates the result of deriving a control signal 162 in the case where the axial movement of the focused spot relative to the medium motion (rotation) is substantially too slow. The control signal is not reproduced correctly in this case. For example, if the focused spot 154 meets (interacts) more than once the same (spiral) track or annular zone it will produce a double “hump” signal 190. A similar signal 190 may be produced by non-homogeneous timing of the appearance of the layer indicating signals as a result of the disc wobble (run-out). If for example annular zones within a recorded layer are separated by 5 microns and the time for the focus point to travel this distance is set to 5 milliseconds (⅕ of a complete rotation for a disk rotating at 40 Hz), then the run-out (due to first harmonic run-out with 100 micron peak-to-peak amplitude) may be 20 micron; a result may be in separated signals from the first and second zones at the same scan. Thus, the movement of the focused reading beam and the carrier rotation should be adjusted such that the speed is substantially faster than the speed of the dominant disk eccentricity wobble motions.

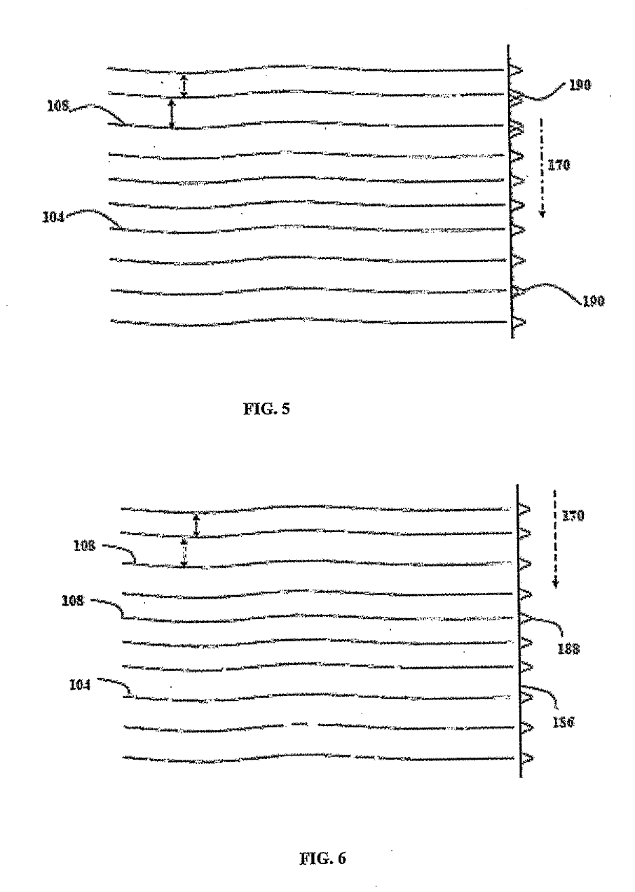

FIG. 6 illustrates the principles of deriving a control signal 162 by proper settings of values and relations of the rotational speed ω of the carrier, and axial 170 and radial 174 speeds of the beam movement. Similar to the above-described cases, peaks 186 and valleys 188 of the signal correspond to the components derived by the axial movement of the focused spot. Peaks 186 correspond to the focused spot 154 location in between the recorded layers and valleys 188 correspond to the focused spot 154 location in at least partially recorded virtual layer 104 or 108. In this example, the signal 162 from mark 114 is lower than the signal generated by focused spot located in the space between the marks/layers. Known low pass filtering technique or other similar technique may be applied to the read out signal to reduce the noise component therein and average the signal component from the marks. Relating the speed ω of the disc rotational movement, speed of the axial motion of the focused spot relative to the medium speed and addition of radial movement of the focused reading spot enables derivation of a proper form control signal indicating on layer/track location.

Turning back to FIG. 3, the output of the detector is connectable (via wires or wireless signal transmission) to the controller (processing unit) 180, which is configured and operable for processing the signal and analyzing the received data to interpret it into the relative depth location of the recorded layers (i.e. arrangement of the multiple layers). The number of signal peaks during the axial movement of the focused spot can now be used for example to count the recorded layers and to control the relative depth position of the scanning read focus within the medium. Analyses of the signal may include determination of the signal frequency, distance from periodicity, pulse shape, and amplitude, and application of various other signal processing techniques such as low pass filtering, matched filters and correlations.

It should be noted that the data carrier may be preformatted with special mark patterns to provide enhancement of the signal to noise ratio of the control signal. For example, use of predefined signal enhancing (full autocorrelation) sequences such as barker coded sequences, conjugated filter sequences or sync sequences may be particularly helpful. Specific frequencies of mark pattern repetition or embedded tones may also be used to extract the control signal.

The recording/formatting carrier 100 quality may be derived from variation of the distance between the layers 104 and 108, derived from the control signal/optical response profile.

As indicated above, the data carrier 100 may be produced with one or more embossed formatting layers. The methods of measurement of the carrier parameters disclosed above are applicable to such type of data carriers. In this case, the measurements may be conducted using the embossed layer spatial position as a reference for optically recorded formatting layers.

Upon determination of the axial location of at least partially recorded layer and locking onto that layer (e.g. by use of a servo mechanism such as disclosed in WO 2005/015552 or co-pending U.S. patent application No. 60/938,510, both being incorporated herein by reference), it is possible to determine the distance between the tracks 120 located in the same virtual layer 104 or 108, determine the quality of the track positioning and count tracks from one tracking position to another (in the layer).

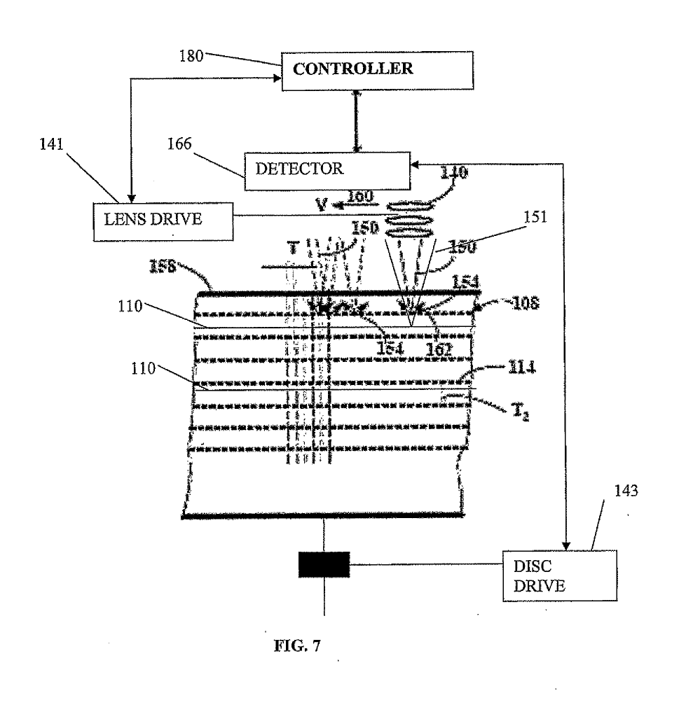

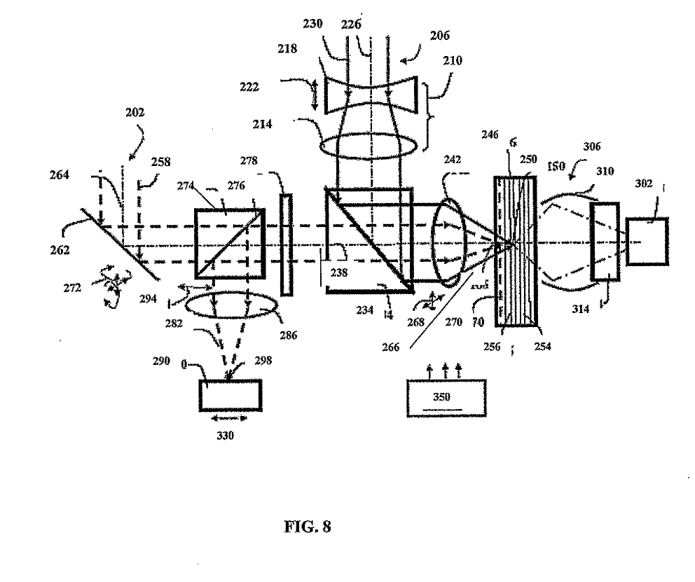

Reference is made to FIG. 7 illustrating schematically the principles of a method of the invention for determining location of tracks residing in the same virtual layer 108 or 104. In this example, the data carrier 100 comprises a reference layer 110, which presents an interface reflective at least to the servo beam located between the recording plates (or between the recording plate and a non-recording plate as the case may be).

An optical system (disc drive system) 140 generates a reading beam 150 and a reference beam 151, and operates to focus these beams on respectively one of the virtual layers 108 and a reference layer 110, to move at least the focused reading beam spot 154 in a radial direction 160 only. This can be implemented by controlling reflection of the reference beam 151 from the reference layer 110, as described in WO07069243 and WO07083308, both being incorporated herein by reference. This technique provides an essentially in-the-layer lock onto the recorded layer even if the disk track suffers from significant run-outs. Interaction of the focused spot with marks 114 recorded on tracks 120 results in a read-out signal (optical response profile) 162 that is collected by detector 166. Measuring the frequency of the signal and the number of peaks in the signal provides for track counting.

Discs typically have substantial axial and radial run outs, typically most pronounced at the frequency of the disc rotation. Because of these run-outs, when the spot tracking is performed in open loop mode, the relative position between the focused spot interactions with the recorded data may change uncontrollably. The effect of the run-outs can be reduced by limiting the time during which at least partially recorded layer is interrogated by the reading spot, while concurrently moving the spot in the radial direction so that, for example, at least 10 tracks are scanned during the time it takes to axially scan the effective depth of a layer.

It should be noted that the control signal also enables to derive indication as to the characteristics of the recorded data within the layers. As noticed above, the recorded marks are sparse in a partially recorded layer as compared to a fully recorded layer. Accordingly, the signal from a fully recorded layer may provide larger difference from the adjacent space surroundings. On the other hand, there may be cases in which it is desirable to get the same signal from all recorded or partially recorded layers and the above mentioned difference may be filtered out, for example, for media in which servo data is frequency multiplexed with the user data as disclosed in a co-pending U.S. patent application No. 60/975,018 which is incorporated herein by reference. In such cases, the user data is typically encoded using a DC free encoding leaving the low frequency regime available for servo information. By choosing a low pass filter responsive only to the servo frequencies, the control signal from all the recorded layers is independent of the contents of the recorded layer.

Thus, a three-dimensional recordable media (non-linear media) body having an axis of symmetry and a thickness, and having a plurality of optically recorded formatting layers centered about the axis of symmetry with each layer and having a plurality of recorded tracks, may be characterized by a control signal generated by interaction of a focused reading scanning spot with regions (comprising marks) recorded about nominal tracks. The focused spot is moving simultaneously in axial and radial direction while maintaining a proper relation between the rotational speed of the disc and linear speed of the reading spot movement in radial direction.

In case the data carrier is being configured with more than one reference layers responsive to (e.g. reflective for) a reference beam and recording/reading beam(s), the scanning may comprise focusing the reference beam onto the first reference layer and focusing the recording/reading beam onto the second reference layer and detecting respective reflection signals, to thereby provide control signals. These control signals enable the determination of the degree of quality of each of the reference layers, the correlation (relation) between the layers and a long range radial scan along the radial direction. The optical system may be locked onto each of the layers respectively and then switched to a master-slave mode wherein only one, first, focus position is locked onto the respective layer, and a focus error signal may be derived being indicative of the degree of focus of the second beam onto the second layer. This enables determination of a degree of quality of correlation (relation) between the respective layers in the focus axis direction. If for example the peak-to peak distance variation between the two layers is 10 microns and the reference beam servo range of operation (i.e. the range for deriving calibrated error signal) is 20 microns, then by locking to the first layer by the reading beam and deriving the error signal in open loop by the servo beam from the second layer (this is a master-slave configuration in which the slave beam is the servo beam), it is possible to estimate the peak-to-peak distance variation between the two layers or to estimate equivalent measures of the reference layers relation (parallelism). Even if the ranges of operation of respective foci (for derivation of focus error signals for the servo beam and the reading/recording beam) is much smaller, it is possible to estimate the reference layers parallelism, e.g. by estimate of the part of the rotation in which a valid focus error signal is derived in the master-slave configuration for the slave beam.

The quality of a specific data carrier or the data carrier type, while in at least partially recorded state (the formatted and/or recorded state of the data carrier), can thus be monitored by means of one or more control signals (optical response profiles) from the data carrier. The degree of quality of the data carrier can be determined by appropriately scanning the data carrier and detecting the control signal(s) from said data carrier, and determining a relation with the predetermined data describing the disc (or disc type)_standard.

As indicated above, in some embodiments of the invention, the determination of the optical response profile of the data carrier requires continuous refocusing of the scanning beam on different layers in the data carrier. In this connection, reference is made to FIG. 8 exemplifying the configuration of the optical system configured to implement such refocusing procedure.

The optical system, generally designated 200 has two light propagation channels, a first channel 202 associated with a first, reference beam and a second channel 206 that provides a second, reading or recoding beam. Light propagation channel 206 includes a beam expander device 210 including a positive lens 214 and a negative lens 218. Negative lens 218, as shown by arrow 222, has a freedom of movement along the system optical axis 226 forming a variable magnification beam expander system providing a variable divergence reading/recoding beam. Generally, beam expander 210 may be a different structure and may for example include two positive lenses.

A beam combiner 234 accepts second beam 230 and changes the direction of beam propagation such that it propagates along an optical axis 238 of objective lens 242. Objective lens 242 focuses beam 230 within the bulk of optical data carrier 246. Changes in the convergence or divergence of the second or recording/reading laser beam 230 would move the beam focal spot 250 along optical axis 238 within the bulk of disc 246. This allows focusing beam 230 on any one of hundreds of different data layers populated with marks recorded in the disc. The reading/recording beam propagation channel 206 in combination with fixed objective element 242 is correcting for spherical aberrations of the variable divergence of reading/recording beam 230 at different focal spot 250 locations in the depth of carrier 246.

Light propagation channel 202 of the system includes a beam expander device (not shown) that collimates the first or reference beam 258. A mirror 262 folds beam 258 optical path such that optical axis 264 of the beam after passing beam combiner 234 coincides with the folded optical axis 226 of the recording/reading beam optical axis and optical axis 238 of objective lens 242. Beam combiner 234 combines beam 230 and 258 such that they form a section of common optical path where optical axis 238 of objective lens 242 becomes a common optical axis of both beams.

Beam 258 may be of wavelength different from the wavelength of beam 230. Lens 242 focuses beam 258 into a spot 266 located in the plane of reference or servo layer 270. Since both beams 230 and 258 are focused by the same objective lens 242, although in different optical planes, the beams are optically coupled. Any movement of objective lens 242 in the plane perpendicular to the drawing, as shown by arrows 268 affects location of both of focal points 250 and 266 simultaneously. The degree at which each of the beams is affected is different, because they have different wavelength and divergence.

Mirror 262 that folds first beam 258 has certain freedom of movement for adjustment purposes around axis 264, as shown by arrows 272 and in direction perpendicular to axis 264. Located in the optical path of reference beam 258 are a beam combiner 274 and a quarter-wave plate 278. Beam combiner 274 folds reflected by the reference layer beam 282 and directs it through a focusing lens 286 onto a Position Sensitive Detector 290 (PSD), for detection of the reference bean reflection. As indicated by arrows 294, lens 286 is capable of lateral movement in the plane perpendicular to the plane of the drawing. Movement of lens 286 changes the location of image 298 of a particular track of reference layer 270 and focal spot 266 formed by lens 286 on detector 290. Quarter wave plate 278 rotates the polarization plane of reflected beam 282 directed towards detector 290 to avoid undesired interference with the original reference beam 258.

Further included in the system is a detector 302 for reading the fluorescence signal generated by interaction of reading beam 230 at focal point 250 with the data. Generally, detector 302 may be located on any of the sides of disc 246. The present example of FIG. 8 relates to a transmission like configuration. Detector 302 may be a Position Sensitive Detector (if the signal to noise ratio is high), or more typically, non-PSD.

The fluorescence signal generated by interaction of focal point 256 of reading beam 230 with recorded data and distributed in the depth of disc 246 recorded marks 256 is a relatively weak signal and therefore a signal collection system 306 consisting of mirrors 310 having curvature of second or higher order and a filter 314 may be used to allow better collection and signal to noise reduction of the fluorescent signal.

While the exemplary embodiments of the present method has been illustrated and described, it will be appreciated that various changes can be made therein without affecting the spirit and scope of the method as defined in by the appended claims.

1. A method for use in determining a degree of quality of a multi-layer optical data carrier in its at least partially recorded state, the method comprising:
providing predetermined first data indicative of a qualified, at least partially recorded multi-layer optical data carrier, said data corresponding to an optical response obtainable from a specific data carrier under predetermined conditions of an optical scan of the rotating data carrier;
scanning a data carrier being qualified by at least one optical beam under said predetermined conditions of the scan, detecting a first control signal from the data carrier and generating data indicative of the detected control signal;
processing said generated data and determining a relation with said predetermined data, and using the determined relation for determining a degree of quality of said scanned data carrier.

2. The method of claim 1, wherein the first control signal has a first spatial profile formed by multiple spaced-apart amplitude peaks corresponding to an arrangement of the multiple layers in the data carrier detectable under said predetermined conditions of the optical scan.

3. The method of claim 1, wherein said predetermined conditions comprise a predetermined relation between a speed of rotation of the data carrier during the scan and a relative displacement between a focus position of the scanning beam and the data carrier.

4. The method of claim 3, wherein said relative displacement is characterized by at least one of an axial speed of the relative displacement between the focus position of the scanning beam and the data carrier along an axis parallel to an optical axis of the scanning beam propagation, and a radial speed of the relative displacement between the focus position of the scanning beam and the data carrier along an axis perpendicular to the optical axis of the scanning beam propagation.

5. The method of claim 3, wherein said predetermined relation is selected to enable detection of each of the layers in the data carrier by an optical response from a predetermined number of recorded regions and spaced between them in said data layer.

6. The method of claim 5, wherein said predetermined relation is selected to enable detection of each of the layers in the data carrier by the optical response from the single recorded region in each data layer.

7. The method of any one of preceding claims, wherein said predetermined data indicative of the optical response from the qualified data carrier comprises information about distances between adjacent layers from the multiple layers in the data carrier.

8. The method of any one of preceding claims, wherein said predetermined data indicative of the optical response from the qualified data carrier comprises information about a location of an endmost layer of the multiple layers with respect to a close thereto outer surface of the data carrier.

9. The method of any one of claims 4 to 8, wherein said optical axis of the beam propagation is parallel to an axis of rotation of the data carrier.

10. The method of any one of preceding claims, comprising:
providing predetermined second data indicative of at least one second optical response obtainable from at least one layer, respectively, in a qualified at least partially recorded optical data carrier state under second predetermined conditions of an optical scan of the rotating data carrier;
scanning at least one layer in the data carrier being qualified by an optical beam under said second predetermined conditions of the scan, and detecting at least one second control signal from said at least one layer in the data carrier and generating data indicative of the detected control signal;
processing said generated data indicative of the detected second control signal and determining a relation with said predetermined second data, and using the determined relation for determining a degree of quality of said scanned data carrier.

11. The method of claim 10, wherein the second control signal has a spatial profile formed by multiple spaced-apart amplitude peaks corresponding to an arrangement of tracks in the layer detectable under said second predetermined conditions of the optical scan of the layer in the rotating data carrier.

12. A method for use in generating data indicative of a degree of quality of at least partially recorded multi-layer optical data carrier, the method comprising: defining conditions for a continuous optical scan of the rotating data carrier along at least an axis substantially parallel to the rotational axis; and applying an optical scan to the data carrier under said predetermined conditions by at least one scanning beam and detecting a control signal indicative of an optical response of the data carrier to said at least one scanning beam, a relation between said control signal and predetermined data indicative of a desired optical signal from a qualified data carrier being indicative of the degree of quality of said scanned data carrier.

13. The method of claim 12, wherein said predetermined conditions comprise a predetermined relation between a speed of the data carrier rotation and a relative displacement between a focus position of the scanning beam and the data carrier.

14. The method of claim 13, wherein said relative displacement is characterized by at least one of an axial speed of the relative displacement between the focus position of the scanning beam and the data carrier along an axis parallel to an optical axis of the scanning beam propagation, and a radial speed of the relative displacement between the focus position of the scanning beam and the data carrier along an axis perpendicular to the optical axis of the scanning beam propagation.

15. A method for use in generating data indicative of a control signal indicating a location of a recorded layer in at least partially recorded multi-layer optical data carrier, the method comprising:
rotating said carrier at a first rotational speed (ω) about its rotational axis;
scanning said rotating data carrier by a focused optical beam in a radial direction with a second radial speed (V);
concurrently moving the focus position of said optical beam with a certain axial speed in a direction parallel to said rotational axis of the carrier, said first and second speeds and the axial speed being synchronized such that said focused scanning beam interacts with at least one recorded region within said carrier;
detecting an optical response of the data carrier to the optical bean during said scanning, and generating data indicative of the corresponding control signal.

16. The method of claim 15, wherein said data indicative of the control signal is generated by at least one interaction of said focused scanning beam with said recorded region.

17. The method of claim 15, wherein said data indicative of the control signal is indicative of the location of at least one of the layers in the data carrier.

18. A method for use in controlling a degree of quality of a three dimensional optical data carrier, said method comprising:
(a) rotating said data carrier at a first rotational speed (ω) about its rotational axis;
(b) simultaneously scanning said rotating data carrier in radial and axial directions by a focused optical beam capable of causing an optical response from the data carrier, and
(c) determining a location of at least one layer according to the focused beam interaction with at least one recorded region in the data carrier, the location of said at least one layer being indicative of the data carrier degree of quality.

19. The method of claim 18, wherein the location of said at least one layer is determined with respect to the outer surface of said data carrier.

20. The method of claim 18, wherein the location of said at least one layer is determined with respect to an adjacent layer in said data carrier.

21. A method for use in determining a track pitch in at least partially recorded three dimensional optical data carrier, said method comprising:
rotating said data carrier at a first rotational speed (ω) about its rotational axis;
scanning said rotating data carrier by a focused optical beam in a radial direction with a second radial speed (V);
concurrently moving the focus position of said optical beam with a certain axial speed in a direction parallel to said rotational axis of the carrier,
detecting an optical response of the data carrier to the optical bean during said scanning, generating data indicative of the corresponding control signal, and using said control signal for determining a location of a recorded layer in the data carrier;
maintaining a reading spot in a selected layer in the data carrier and moving said spot in a radial direction in a reciprocating movement;
detecting an optical signal from the data carrier during said movement and determining the pitch between two adjacent tracks according to said movement.

22. A method for use in determining parameters of a three dimensional optical data carrier, said method comprising:
(a) rotating said carrier at first speed (ω) about its rotational axis;
(b) simultaneously scanning said rotating carrier in radial and axial directions by a focused optical beam capable of interacting with a recorded region in the data carrier and causing an optical response from the data carrier, and
(c) detecting said optical response and determining the location of at least one layer in the data carrier.

23. The method according to claim 22, wherein said data carrier parameters include at least one of the following: location of at least one of the layers in the data carrier, a distance between the tracks in the layer, a distance between at least one of the layers and an upper or lower surface of the data carrier, and axial and radial run-out of the scan.

24. Data storable in machine readable media and retrievable as a machine readable code, said data being indicative of a qualified at least partially recorded multi-layer optical data carrier and corresponding to a result of an optical response profile obtainable from a specific data carrier under predetermined conditions of an optical scan of the rotating data carrier along axial and radial directions of the scan.

25. The data of claim 24, comprising various relations between various signal obtainable from the data carrier and a required control signal, said relations defining various degrees of quality of the data carrier.

26. A control signal structure characterizing at least partially recorded multi-layer optical data carrier, said control signal comprising multiple spaced-apart peaks corresponding to an arrangement of the multiple recorded layers in the carrier.

27. The control signal of claim 26, wherein a number of said multiple spaced-apart peaks corresponds to a number of the at least partially recorded layers in the data carrier.

28. The control signal of claim 27, wherein each of said multiple peaks correspond to an optical response from a recorded region in the respective layer to an interacting focused optical beam during the data carrier rotation with a predetermined rotational speed and the focused optical beam scan along an axis parallel to the axis of rotation.

29. The control signal according to any one of claims 26-28, being a result of signal processing of an optical response of the data carrier to an optical beam, said signal processing including processing of temporal and spatial characteristics of said optical response.

30. The control signal of any one of claims 26-29, further comprising information about a number of tracks residing in the at least one layer scanned by an optical beam along at least one optical axis passing through said layer.

31. The control signal according to claim 30, being a result of signal processing of an optical response of said at least one layer to the scanning beam, said signal processing including processing of temporal and spatial characteristics of said optical response of the layer generated by the scanning beam propagation axis interaction with at least one track in the layer.

32. The control signal according to claim 30 to 31, being indicative of the number of layers in said data carrier and the number tracks in each of the layers.

33. A drive system for recording/reading data in an optical multi-layer data carrier, the drive system being configured and operable for irradiating the data carrier with at least one focused optical beam to cause an optical response from the data carrier, and detecting and analyzing said optical response to determine data indicative of at least one of the following: a relation between the drive system and the data carrier; and the data carrier arrangement.

34. The drive system according to claim 33, wherein said data indicative of the relation between the drive system and the data carrier comprises information about a position of the focal plane of the optical beam relative to a certain location in the data carrier.

35. The drive system according to claim 34, wherein said data indicative of the relation between the drive system and the data carrier comprises information about the position of the focal plane of the optical beam relative to an outer surface of the data carrier.

36. The drive system according to claim 34, wherein said data indicative of the relation between the drive system and the data carrier comprises information about the position of the focal plane of the optical beam relative to a reference layer plane in the data carrier.

37. The drive system according to claim 34, wherein said data indicative of the data carrier arrangement comprises information about the arrangement of layers in the data carrier.

38. The drive system according to claim 34, wherein said data indicative of the data carrier arrangement comprises information about distances between the layers in the data carrier.

39. The drive system according to claim 38, wherein said data indicative of the data carrier arrangement comprises information about distances between the layers in the data carrier comprises information about at least one of the following: a distance between reference layers, and a distance between a data layer and a reference layer.

40. A drive system for recording/reading data in an optical multi-layer data carrier, the drive system being configured and operable for scanning a data carrier by at least one focused optical beam under predetermined condition of the scanning, detecting an optical response of the data carrier to said at least one focused optical beam, and generating a control signal indicative thereof said control signal being indicative of a degree of quality of the data carrier.

41. The drive system according to claim 40, comprising an optical unit for generating and focusing said at least one optical beam and detecting the optical response of the data carrier, a drive mechanism configured for rotating the data carrier, and a control unit for processing the detected data to determine the corresponding control signal.
